(19) United States
(12) Patent Application Publication
(10) Pub. No.: US 2023/0210123 A1
(43) Pub. Date: Jul. 6, 2023

(54) METHODS FOR PRODUCING A FERMENTED PLANT-BASED FOOD PRODUCT

(71) Applicants: Icelandic Provisions, Inc., new York, NY (US); MS Iceland Dairies, Reykjavík (IS)

(72) Inventors: Nicolaas H. Bevers, Beneden Leeuwen (NL); John Heath, Brooklyn, NY (US); Ólafur Unnarsson, Selfoss (IS); Biõrn S. Gunnarsson, Reykjavík (IS)

(21) Appl. No.: 17/924,816

(22) PCT Filed: May 12, 2021
(86) PCT No.: PCT/US2021/031925

§ 371 Date: Nov. 11, 2022

Related U.S. Application Data
(60) Provisional application No. 63/024,155, filed on May 13, 2020.
(60) Provisional application No. 63/077,269, filed on Sep. 11, 2020.
(60) Provisional application No. 63/092,058, filed on Oct. 15, 2020.
(60) Provisional application No. 63/115,926, filed on Nov. 19, 2020.

(30) Foreign Application Priority Data
Jun. 2, 2020 (EP) 20177847.9

(51) Int. Cl. A23C 11/10

(52) U.S. Cl. CPC A23C 11/106; A23C 2260/05; A23C 2220/10; A23C 2220/20

(57) ABSTRACT

Methods related to producing a fermented plant-based food product comprising high protein content.

### RELATED APPLICATIONS

This application claims the benefit of priority to U.S. Provisional Patent Applications having Ser. No. 63/024,155 filed May 13, 2020, 63/077,269 filed Sep. 11, 2020, 63/092,058 filed Oct. 15, 2020, and 63/115,926 filed Nov. 19, 2020, and European Patent Application having serial number 20177847.9 filed Jun. 2, 2020, the entire contents of each of which are hereby incorporated by reference in their entirety.

### BACKGROUND

Traditional yogurt is a food product made by fermenting milk with bacterial cultures. Greek yogurt and Icelandic yogurt (“skyr”) have many dietary benefits; it is high in protein and has shown to enhance healthy gut bacteria. High protein content and thick texture are key drivers of the commercial success these varieties of yogurt have experienced over the past decade.

Recently, dairy-free yogurts have gained popularity due to the prevalence of dietary restrictions and the significant drawbacks of industrial animal agriculture. These products include yogurts made from plants such as legumes (soybeans), nuts (almonds, hazelnuts, cashews), grains (oats, rice), and/or fruits (coconuts). At the moment, many plant-based yogurts on the market contain excess sugar and an abundance of stabilizers that have little nutritional value. The majority of these products are also gelatinous, runny in texture, and lack protein. A key challenge in the industry is that plant bases that are used to make non-dairy yogurts lack the “food chemistries” and other properties that make cow's milk ideal for fermentation and yogurt making. The bacteria used in fermentation require the yogurt base to have ample protein in order to build texture, taste, and mouthfeel in plant-based yogurt. Because most plant bases have low protein content, one solution is to concentrate the plant base. However, when typical concentration methods are used the carbohydrate levels in a concentrated plant-base far exceed what a consumer would expect in a plant-based yogurt.

There is currently an unmet need for a plant-based yogurt with high protein content, low-carbohydrate content, thick texture, and no added stabilizers. Presently, no cultured yogurt product exists on the market that is made exclusively from plant-protein, water, and bacterial cultures.

### SUMMARY

In certain aspects, provided herein are methods related to the production of a plant-based yogurt product with high protein content, low carbohydrate content, thick texture, pleasing mouthfeel and/or no added stabilizers.

In certain aspects, the methods of producing a plant-based food product provided herein comprise the steps of (a) adding lactic acid bacteria and optionally a plurality of enzymes to a plant base (e.g., oat base) comprising no less than 1.0%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3% total protein; b) fermenting the plant base to generate a fermented plant base; and (c) concentrating the fermented plant base by ultra-filtration to generate a non-dairy food product comprising increased protein content (e.g., at least 5%, at least 5.5%, at least 6%, at least 6.5%, at least 7%, at least 7.5%, at least 8% total protein). In certain embodiments, centrifugal separation (e.g., using a Q517 dairy separator) is used instead of ultra-filtration in step (c). In some embodiments, the plant base comprises no less than 2.5% total protein. In certain embodiments, the plant base comprises no less than 3% total protein.

In certain aspects, provided herein are methods of producing a plant-based food product comprising the step of (a) concentrating (e.g., by ultra-filtration if it is desired to lower the carbohydrate content, otherwise reverse osmosis can be used) a plant base (e.g., oat base) comprising less than 1% total protein to produce a pre-concentrated plant base comprising at least 3% total protein. In certain embodiments, the method further comprises the step of (b) adding lactic acid bacteria and optionally a plurality of enzymes to the concentrated plant base. In certain embodiments, the method also comprises the step of (c) fermenting the pre-concentrated plant base to generate a fermented plant base. In some embodiments, the method comprises the step of (d) concentrating the fermented plant base by ultra-filtration to generate a non-dairy food product comprising increased protein content (e.g., at least 5%, at least 5.5%, at least 6%, at least 6.5%, at least 7%, at least 7.5%, at least 8% total protein). In certain embodiments, centrifugal separation (e.g., using a Q517 dairy separator) is used instead of ultra-filtration in step (d).

In certain aspects, provided herein is a method of producing a plant-based food product comprising the steps of (a) diluting (e.g., by a factor of at least 2, at least 3, at least 4, at least 5, at least 6, at least 7, at least 8, at least 9, at least 10) a concentrated plant base (e.g., oat base) comprising greater than 1% (e.g., greater than 1.5%, greater than 2%, greater than 2.5%, greater than 3%) total protein to form a diluted plant base; (b) concentrating (e.g., by ultra-filtration if it is desired to lower the carbohydrate content, otherwise reverse osmosis can be used) the diluted plant base to produce a re-concentrated plant base comprising at least 1.0%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3.0% total protein. In some embodiments, the amount of water to be added during the dilution step is dependent on how much of the carbohydrate content is to be removed by the subsequent concentration step. In certain embodiments, the method further comprises the step of (c) adding lactic acid bacteria and optionally a plurality of enzymes to the pre-concentrated plant base. In some embodiments, the method includes the step of (d) fermenting the re-concentrated plant base to generate a fermented plant base. In some embodiments, the method includes the step of (e) concentrating the fermented plant base by ultra-filtration to generate a non-dairy food product comprising increased protein content (e.g., at least 5%, at least 5.5%, at least 6%. At least 6.5%, at least 7%, at least 7.5%, at least 8% total protein). In certain embodiments, centrifugal separation (e.g., using a Q517 dairy separator) is used instead of ultra-filtration in step (c). In some embodiments, the r-concentrated plant base comprises at least 2.5% total protein. In certain embodiments, the re-concentrated plant base comprises at least 3% total protein.

In certain aspects, provided herein is a method of producing a plant-based food product comprising the step of (a) diluting (e.g., by a factor of at least 2, at least 3, at least 4, at least 5, at least 6, at least 7, at least 8, at least 9, at least 10) a concentrated plant base (e.g., oat base) comprising greater than 3.5% (e.g., greater than 4%, greater than 4.5%, greater than 5%, greater than 5.5%) total protein to form a diluted plant base. In some embodiments, the plant base is diluted with water. In some embodiments, extraneous protein (e.g., extraneous plant protein) is added to the diluted plant base. In some embodiments, the extraneous protein is added to increase the protein content of the diluted plant base to at least 3% total protein. In certain embodiments, the method further comprises the step of (b) adding lactic acid bacteria and optionally a plurality of enzymes to the diluted plant base. In some embodiments, the method includes the step of (c) fermenting the diluted plant base to generate a non-dairy food product comprising increased protein content (e.g., at least 5%, at least 5.5%, at least 6%. At least 6.5%, at least 7%, at least 7.5%, at least 8% total protein). In some embodiments, the method includes concentrating the fermented plant base by ultra-filtration to generate a non-dairy food product comprising increased protein content (e.g., at least 5%, at least 5.5%, at least 6%, at least 6.5%, at least 7%, at least 7.5%, at least 8% total protein). In certain embodiments, centrifugal separation (e.g., using a Q517 dairy separator) is used instead of ultra-filtration.

In certain aspects, the methods of producing a plant-based food product provided herein comprise the step of adding extraneous protein (e.g., plant protein) to a plant base (e.g., oat base) that has less than 3% total protein (e.g., less than 2.5% total protein, less than 2% total protein, less than 1.5% total protein, less than 1% total protein) to generate a supplemented plant base that has at least 3% total protein (e.g., at least 3.5% total protein, at least 4% total protein). In some embodiments, the method further comprises a step of (b) adding lactic acid bacteria and optionally a plurality of enzymes to the supplemented plant base. In certain embodiments, the method further comprises the step of (c) fermenting the plant base to generate a non-dairy food product comprising increased protein content (e.g., at least 5%, at least 5.5%, at least 6%, at least 6.5%, at least 7%, at least 7.5%, at least 8% total protein). In some embodiments, the method includes concentrating the fermented plant base by ultra-filtration to generate a non-dairy food product comprising increased protein content (e.g., at least 5%, at least 5.5%, at least 6%. At least 6.5%, at least 7%, at least 7.5%, at least 8% total protein). In certain embodiments, centrifugal separation (e.g., using a Q517 dairy separator) is used instead of ultra-filtration.

In certain aspects, the methods of producing a plant-based food product provided herein comprise the step of (a) adding lactic acid bacteria and optionally a plurality of enzymes to a plant base (e.g., oat base) comprising no less than 3% total protein. In some embodiments, extraneous protein is added to the plant base. In certain embodiments, the method further comprises the step of (b) fermenting the plant base to generate a non-dairy food product comprising increased protein content (e.g., at least 5%, at least 5.5%, at least 6%, at least 6.5%, at least 7%, at least 7.5%, at least 8% total protein). In some embodiments, the method includes concentrating the fermented plant base by ultra-filtration to generate a non-dairy food product comprising increased protein content (e.g., at least 5/a, at least 5.5%, at least 6%. At least 6.5%, at least 7%, at least 7.5%, at least 8% total protein). In certain embodiments, centrifugal separation (e.g., using a Q517 dairy separator) is used instead of ultra-filtration.

In certain aspects, provided herein are food products made according to a method provided herein.

### DETAILED DESCRIPTION

### General

In certain aspects, provided herein are methods related to the production of a plant-based yogurt product with high protein content, low carbohydrate content, thick texture, pleasing mouthfeel and/or no added stabilizers.

A key challenge is that plant bases that are used to make non-dairy yogurts lack the “food chemistry” and properties that make cow's milk ideal for fermentation and yogurt making. (exhibit showing oat milk example versus cow's milk). In order to build texture, taste and mouthfeel in traditional dairy fermentation the bacteria need to have ample protein. However, when concentrated plant bases were used it would frequently result in unacceptable sugar levels in the final product.

As disclosed herein, to address this carbohydrate issue the instant inventors applied ultra-filtration and/or reverse osmosis technologies to the processing of plant bases (and particularly oat bases) in order to wash out the sugars/carbohydrates (via ultra-filtration) as well as concentrate the proteins before fermentation (via ultra-filtration and/or reverse osmosis). One challenge with this approach is that there are no guidelines for using this type of equipment for the processing of plant bases or for such purposes. Similarly, to address further increase protein levels the instant inventors also used ultra-filtration concentration and/or centrifugal separation methods post-fermentation. Again there were no guidelines for using this type of equipment for the processing of plant based yogurts.

As disclosed herein, through the novel application of ultra-filtration, centrifugal separation, and reverse osmosis technologies to the generation of plant-based food products, the instant method allows for the production of a high-protein, low-sugar yogurt product. The resulting product further can have a thick texture and good mouth-feel without the need to add extraneous stabilizers. Moreover, the instant method also allows the generation of the high-protein yogurt product without the addition of extraneous protein to the product (though, in some embodiments extraneous protein can be added to further increase the protein content of the end product).

### Definitions

The “protein content” or “total protein” of a composition corresponds to the weight of the proteins present in the composition relative to the total weight of the composition. The protein content is expressed as a weight percentage. The protein content may be measured by Kjeldahl analysis (NF EN ISO 8968-1) as the reference method for the determination of the protein content of dairy products based on measurement of total nitrogen. Nitrogen is multiplied by a factor, typically 6.38 for milk protein (and a lower number for oat protein, around 5.83), to express the results as total protein. The method is described in both AOAC Method 991.20 (1) and International Dairy Federation Standard (IDF) 20B:1993. Usually the total protein content is known for all the ingredients used to prepare the product, and total protein content is calculated from these data.

A “carbohydrate” refers to a sugar or polymer of sugars. The terms “saccharide,” “polysaccharide,” “carbohydrate,” and “oligosaccharide” may be used interchangeably. Most carbohydrates are aldehydes or ketones with many hydroxyl groups, usually one on each carbon atom of the molecule. Carbohydrates generally have the molecular formula CₙH₂ₙOₙ. A carbohydrate may be a monosaccharide, a disaccharide, trisaccharide, oligosaccharide, or polysaccharide. The most basic carbohydrate is a monosaccharide, such as glucose, sucrose, galactose, mannose, ribose, arabinose, xylose, and fructose. Disaccharides are two joined monosaccharides. Exemplary disaccharides include sucrose, maltose, cellobiose, and lactose. Typically, an oligosaccharide includes between three and six monosaccharide units (e.g., raffinose, stachyose), and polysaccharides include six or more monosaccharide units. Exemplary polysaccharides include starch, glycogen, and cellulose. Carbohydrates may contain modified saccharide units such as 2′-deoxyribose wherein a hydroxyl group is removed, 2′-fluororibose wherein a hydroxyl group is replaced with a fluorine, or N-acetylglucosamine, a nitrogen-containing form of glucose (e.g., 2′-fluororibose, deoxyribose, and hexose). Carbohydrates may exist in many different forms, for example, conformers, cyclic forms, acyclic forms, stereoisomers, tautomers, anomers, and isomers.

As used herein a “lipid” includes fats, oils, triglycerides, cholesterol, phospholipids, fatty acids in any form including free fatty acids. Fats, oils and fatty acids can be saturated, unsaturated (cis or trans) or partially unsaturated (cis or trans). The “fat content” of a composition corresponds to the weight of the fat components present in the composition relatively to the total weight of the composition. The fat content is expressed as a weight percentage. The fat content can be measured by the Weibull-Berntrop gravimetric method described in the standard NF ISO 8262-3. Usually the fat content is known based on the fat content of the ingredients used to prepare the composition, and the fat content of the product is calculated based on these data.

The term “reduced carbohydrate concentration” is used herein to describe a product or composition that has a lower carbohydrate concentration relative to a product or composition, in an initial state and/or produced according to standard processes used for making strained acidic, non-dairy products. In certain embodiments the carbohydrate concentration is reduced by at least 5%, 10%, 15%, 20%, 25%, 30%, 35%, 40%, 45%, 50%, or more.

The term “percent by weight” is based on a total weight of the corresponding product, if not otherwise specified. For example, a material, composition or product comprising carbohydrates in an amount of 2.00% by weight means 2.00% by weight based on the total weight of the material, composition or product.

The “dry matter” of a product corresponds to the weight of non-volatile components present in the product relatively to the total weight of the product. The dry matter is expressed as a weight percentage. The “non-volatile components” correspond to the solids that remain after an evaporation step of the product at 103-105° C. The dry matter can be measured by the method disclosed in NF V04 370 comprising a heating step at 102° C. Usually the dry matter is known for all the ingredients used to prepare the product, and dry matter is calculated from these data.

The term “plant” refers to any organism of the kingdom Plantae and includes plants described as grains, fruits and vegetables as well as plant parts, such as root, stem, trunk; caulis, leaf, lamina, fruit, flower, seed or bark. In certain embodiments provided herein, the plant is oat.

The term “plant base” refers to a food product consisting mostly or entirely of foods derived from plants, including vegetables, grains, nuts, seeds, legumes, and fruits, and with few or no animal products. In certain embodiments provided herein, the plant base is an oat base.

The term “exopeptidase” refers to a peptidase that is capable of catalyzing the cleavage of individual amino acids at the ends of a peptide chain.

### Plant Base Material

In certain aspects, provided herein are methods to generate a non-dairy food product from a plant base material. In some embodiments, the plant base materials are rice, hazelnut, walnut, soy, tiger nut, hemp, buckwheat, almonds, cashews, cashew, pili, coconut, flax seeds, plantains, oats, peas, and/or combinations thereof. In some embodiments, the plant base material is a plant base milk. Plant base milk may include milk derived from oats, soy, rice, almond, flax, coconut, sunflower, pea, cashew, peanut, others, and/or combinations thereof. In some embodiments, the plant base is in a powdered, dried, dehusked, steel cut, or rolled, or any other form. These can be stabilized (i.e. treated with a heat source like steam to inactivate certain naturally occurring enzymes such as lipase) or un-stabilized (not treated with a heat source). It is preferable to use a raw material with a high content of protein preserved in its natural state. “Preserved in its natural state” signifies that the protein in the raw material has not been denaturated or has only been denaturated to a minor extent, such as by 10% by weight or 20% by weight.

In some embodiments the plant base is an oat base. In some embodiments the plant base is a dry oat base. In some embodiments the plant base is an aqueous oat base. In some embodiments, the plant base is an oat milk. In some embodiments the oat base is comprises oat bran particles. Oat bran is the cell wall layer enclosing the oat endosperm and germ from which it can be separated by milling techniques. In some embodiments, the oat base comprising oat bran particles is oat bran, whole groat meal (whole meal), rolled oats, groats or oat endosperm flour. In some embodiments, the oat bran particles may have an average size of 25 μm or higher.

In some embodiments, the oats used for producing oat-based food product are dry-heated or wet-heated prior to use as starting material for producing oat-based food products. The purpose of heat treatment is to inactivate lipase and lipoxygenase. Inactivation of lipase and lipoxygenase is indicated to prevent the product from turning rancid. Heat treatment with steam should be avoided or at least be kept as short as possible and/or carried out at a temperature as low as possible to keep oat protein denaturation low. In some embodiments, the oat base material is dehulled or hulless/naked, dry milled oat flour that has not been heat treated, particularly steamed. However, wet milled oat flour that has not been heat treated or dry milled flour of any oats fraction can also be used. Particularly preferred is the use of dry milled non-heat treated oats, non-heat treated oat bran, and non-steamed oats. Oat-based food products are described in US 2004/0258829, US 2012/0034341, US 2016/0106125, US 2019/0191730, WO 2014/123466, WO 2000/30457, EP 2996492, incorporated by reference in its entirety.

In some embodiments, the plant base is optionally pasteurized prior to fermentation. In some embodiments, the plant base is optionally pasteurized at 83° C., 84° C., 85° C., 86° C., 87° C., 88° C. 89° C., 90° C., 91° C. 92° C., 94° C., 95° C. 96° C., of 97° C. In some embodiments, the plant base is optionally pasteurized, for 2, 3, 4, 5, 6, 7, 8 minutes.

In some embodiments, the plant base is optionally homogenized prior to fermentation. In some embodiments, the plant base is optionally homogenized prior to pasteurization. In some embodiments, the plant base is homogenized at 100, 150, 200, 250, 300, 350, 400, 450 Mpa.

In some embodiments, extraneous protein is optionally added to the plant base. In some embodiments, extraneous protein is optionally added to the plant base prior to fermentation. In some embodiments, the extraneous protein is optionally added to the plant base prior to homogenization. The extraneous protein may be sourced from an animal or a plant.

In some embodiments, probiotic bacteria are optionally added to the plant base.

In some embodiments, yeast and/or mold are optionally added to the plant base.

In some embodiments, the plant base comprises no less than 1% total protein. In some embodiments, the plant base comprises 3-4% total protein. In some embodiments, the plant base comprises 3.1/a, 3.2%, 3.3%, 3.4%, 3.5%, 3.6%, 3.7%, 3.8%, 3.9%, 4% total protein. In some embodiments, the plant base comprises about 3.5% total protein. In some embodiments the plant base is fermented at 40-46° C. In some embodiments, the plant base is fermented at 43° C. In some embodiments, the plant base is fermented for at least 3 hours. In some embodiments, the plant base is fermented for 3-5 hours. In some embodiments, the fermented plant base has a pH of about 4-5.

In some embodiments, a plant base comprising less than 1% total protein is concentrated to produce a pre-concentrated plant base comprising at least 3% total protein. In some embodiments, the plant base comprising less than 1% total protein is concentrated by ultra-filtration or reverse-osmosis to produce the pre-concentrated plant base. In some embodiments, the pre-concentrated plant base comprises 3-4% total protein. In some embodiments, the pre-concentrated plant base comprises about 3.5% total protein. In some embodiments the pre-concentrated plant base is fermented at 40-46° C. In some embodiments, the pre-concentrated plant base is fermented at 43° C. In some embodiments, the pre-concentrated plant base is fermented for at least 3 hours. In some embodiments, the pre-concentrated plant base is fermented for 3-5 hours. In some embodiments, the fermented plant base has a pH of about 4-5.

In some embodiments, the plant base is a concentrated plant base comprising at least 3% total protein. In some embodiments the concentrated plant base is diluted to form a diluted plant base comprising no more than 2% total protein (e.g., about 1% total protein). In some embodiments, the concentrated plant base is diluted in water. In some embodiments, the concentrated plant base is diluted in another plant base. The carbohydrate concentration by weight of the diluted plant base is lower than the concentration by weight of carbohydrate of the material or product, particularly at least twice lower, more particularly at least 10 times lower. The diluted plant base is still more particularly substantially free of carbohydrate. In some embodiments, the diluted plant base comprises no greater than 8% total carbohydrates. In some embodiments, the diluted plant base comprises 3%, 4%, 5%, 6%, 7%, or 8% total carbohydrates. In some embodiments, diafiltration may be used to remove carbohydrates from the plant base. In some embodiments, the diluted plant base is concentrated to produce a pre-concentrated plant base comprising about 2% total protein. In some embodiments, the diluted plant base is concentrated by ultra-filtration or reverse-osmosis to produce the pre-concentrated plant base. In some embodiments, the pre-concentrated plant base comprises 3-4% total protein. In some embodiments, the pre-concentrated plant base comprises about 3.5% total protein. In some embodiments the pre-concentrated plant base is fermented at 40-46° C. In some embodiments, the pre-concentrated plant base is fermented at 43° C. In some embodiments, the pre-concentrated plant base is fermented for at least 3 hours. In some embodiments, the pre-concentrated plant base is fermented for 3-5 hours. In some embodiments, the fermented plant base has a pH of about 4-5%.

### Fermentation

In certain aspects, provided herein are methods to generate a non-dairy food product by fermentation. In some embodiments, the process involves a fermentation step with at least one strain of lactic acid bacteria. In this step, a liquid plant base material is inoculated with lactic acid bacteria and the mixture is then allowed to ferment at a fermentation temperature. Such inoculation and fermentation operations are known by those of skill in the art. If such a fermentation step is performed, the initial plant base material should contain lactose, glucose, galactose or a mixture thereof, which is well known to the one skilled in the art.

During fermentation, the lactic acid bacteria produce lactic acid, which leads to a decrease in pH. As the pH decreases, proteins coagulate to form a curd, typically at a breaking pH. The breaking pH can be more particularly from 3.5 to 5.0, even more particularly from 4.00 to 5.00, and still more particularly from higher than 4.50 to 4.80. In some embodiments, the pH of the fermented plant base is about 4-5.

In some embodiments, the fermentation temperature may be from 35° C. to 50° C., and more particularly from 40° C. to 46° C. In some embodiments, the fermentation is 34° C., 35° C. 36° C., 37° C. 38° C., 39° C., 40° C., 41° C., 42° C., 43° C., 44° C., 45° C., 46° C., 47° C., 48° C., 49° C., 50° C., or 51° C. In some embodiments, the fermentation temperature is 43° C.

In some embodiments, the plant base is fermented for at least 3 hours. In some embodiments, the plant base is fermented for 3, 4, 5, 6, 7, 8, or more hours. In some embodiments of the methods provided herein, fermentation of a plant base is performed by optionally adding a plurality of enzymes is optionally added to the plant base. In some embodiments, fermentation of a plant base is performed with a transglutaminase enzyme. Transglutaminase is an enzyme produced by Streptomyces mobaraensis. An example of a transglutaminase product used in fermentation is BDF PROBIND CH 2.0 (BDF Ingredients), which comprises a mixture of transglutaminase, milk proteins, and lactose.

In some embodiments of the methods provided herein, fermentation of a plant base is performed with an exopeptidase. Exopeptidases are used to reduce the bitter flavor of the non-dairy food product. Exopeptidases cleave amino acids from the C- or N-terminus of a polypeptide chain. Exopeptidases can be used to control bitterness by removing bitter-tasting peptides. Typically, the exopeptidase will be a food-grade enzyme having optimal activity at a pH from about 6.0 to about 8.0 and at a temperature from about 50° C. to about 60° C. The exopeptidase may be of microbial origin. Examples of exopeptides suitable for use in the process of the invention include Flavorpro™ 937MDP (Biocatalysts) (Table 1), aminopeptidase from Aspergillus oryzae (SEQ ID NO: 2 in International Application No. WO 96/28542 incorporated by reference in its entirety, aminopeptidase from Bacillus lichenformis (UNIPROTE: Q65DH7), carboxypeptidase D from Aspergillus oryzae (UNIPROT: Q2TZ 11), carboxypeptidase Y from Aspergillus oryzae (UNIPROT: Q2TYA 1), combinations thereof.

TABLE 1
Specifications of Flavorpro ™ 937MDP

| | |
|---|---|
| Activity | Leucine Aminopeptidase 350 U/g |
| Biological Source | Aspergillus oryzae |
| Form | Off-white to pale brown powder |
| Optimum pH Range | 5.0-7.0 |
| Optimum Temperature Range | 45-55° C. |

In some embodiments of the methods provided herein, fermentation of a plant base is performed with an amylase enzyme. Amylase enzymes increase the glucose or maltose content of the plant base to facilitate fermentation by lactic acid bacteria. The amylase may be alpha amylase, beta amylase or a mixture thereof. The amylases are added in amount(s) sufficient for significant hydrolysis of starch over a time period of less than 6 hrs, from 0.5 h to 4 hrs, in particular from about 1 h to about 2 hrs, hydrolysis of more than 50% by weight of the starch, in particular of more than 80% by weight or even more than 90% weight being considered significant. Typically, the amylase(s) are added in an amount to provide amylase activity of from 140 to 250 Betamyl-3 units and from 0.5 to 4 Ceralpha units per g of starch, in particular of about 180 Betamyl-3 units and about 1 Ceralpha unit per g of starch. A preferred temperature to contact the plant base material with alpha amylase or beta amylase is a temperature from 30° C. to 70° C., in particular from 55° C. to 65° C., more preferred at about 60° C. Amylase enzymes can be added if the liquid plant base material does not contain enough fermentable sugars. Amylase enzymes can be added before the lactic acid bacteria are added or at the same time or at some point after the lactic acid bacteria have been added, depending on the starting concentration of fermentable sugars and/or depending on the final carbohydrate content that is desired after deactivation of these enzymes through cooling of the fermented product.

### Lactic Acid Bacteria

In certain aspects, provided herein are methods to generate a non-dairy food product by fermentation involving lactic acid bacteria. Appropriate lactic acid bacteria are known by those of skill in the art. Lactic acid bacteria may be referred to herein as ferments or cultures or starters. Examples of lactic acid bacteria that can be used include: Lactobacilli, for example, Lactobacillus acidophilus, Lactobacillus casei, Lactobacillus paracasei, Lactobacillus plantarum, Lactobacillus reuteri, Lactobacillus johnsonii, Lactobacillus helveticus. Lactobacillus brevis, Lactobacillus rhamnosus; Streptococci, for example, Streptococcus thermophilus, Streptococcus cremoris, Bifidobacteria, for example, Bifidobacterium bifidum, Bifidobacterium longurm, Biftdobacterium breve, Bifidobacterium animalis, Lactococci, for example, Lactococcus lactis subsp. lactis, Lactococcus lactis subsp. cremoris, Propionibacterium such as, Propionibacterium, freudenreichii, Propionibacterium freudenreichii ssp shermanii, Propionibacterium acdipropionici, Propionibacterium thoenii, and mixtures and/or combinations thereof.

The lactic acid bacteria may comprise, may essentially consist of, or may consist of, Lactobacillus delbrueckii ssp. bulgaricus (i.e. Lactobacillus bulgaricus) and Streptococcus salivarius ssp. thermophilus (i.e. Streptococcus thermophilus) bacteria. The lactic acid bacteria used in the invention typically comprise an association of Streptococcus thermophilus and Lactobacillus bulgaricus bacteria. This association is known and often referred to as a yogurt symbiosis. Examples include culture YoMix® 495 marketed by Dupont.

The lactic acid bacteria used in the invention typically comprise an association of Streptococcus thermophilus, Lactobacillus bulgaricus bacteria and Lactobacillus acidophilus, in particular two Lactobacillus acidophilus.

In some embodiments, the lactic acid bacteria to be used in the present invention are selected from: Lactobacillus delbrueckii subsp. bulgaricus deposited under the number CNCM 1-1632 or Lactobacillus delbrueckii subsp. bulgaricus deposited under the number CNCM I-1519, or Lactobacillus delbrueckii subsp. bulgaricus deposited under the number CNCM I-2787 Lactobacillus acidophilus deposited under the number CNCM I-2273, Lactobacillus rhamnosus deposited under the number CNCM 1-4993, Streptococcus thermophilus deposited under the number CNCM-1630, or Streptococcus thermophilus deposited under the number CNCM-4992 or Streptococcus thermophilus deposited under the number CNCM-5030. Lactococcus lactis subsp. lactis deposited under the number CNCM-1631, Lactococcus lactis subsp. cremoris deposited under the number CNCM-3558, Bifidobacterium aninalis subsp. lactis deposited under the number CNCM-2494, and combinations thereof. The above-mentioned lactic acid bacteria have been deposited under the Budapest treaty at the Collection Nationale de Cultures de Micro-organismes (CNCM) located at Institut Pasteur's headquarters (25 rue du Docteur Roux 75724 PARIS Cedex 15 FRANCE).

In some embodiments, other bacteria may be added during fermentation, and such may comprise probiotic bacteria. Probiotic bacteria are known by those of skill in the art. Examples of probiotic bacteria include, for example, some Bifidobacteria and Lactobacilli, such as Bifidobacterium brevis, Bifidobacterium aninalis, Bifidobacterium animalis lactis, Bifidobacterium infantis, Bifidobacterium longum, Lactobacillus helveticus, Lactobacillus casei, Lactobacillus casei paracasei, Lactobacillus acidophilus, Lactobacillus rhamnosus, Lactobacillus plantarum, Lactobacillus reuteri, Lactobacillus delbrueckiisubspbulgaricus, Lactobacillus delbrueckiisubsplactis, Lactobacillus brevis, Lactobacillus fermentum, and mixtures thereof.

The lactic acid bacteria may be introduced in any appropriate form, for example, in a spray-dried form, a freeze-dried form or in a frozen form, preferably in a liquid form. The introduction of the lactic acid bacteria in the plant base material is also referred to as an inoculation.

In some embodiments, the fermented, non-dairy product has lactic acid bacteria in a live or viable form.

In some embodiments, the lactic acid bacteria used in the invention typically comprise a culture of Bifidobacterium species. Lactobacillus acidophilus, Lactobacillus delbrueckii subsp. bulgaricus, Lactobacillus paracasei, and Streptococcus thermophiles. An example of a lactic acid bacteria product used for fermentation is YoFlex® YF-L02 DA (CHR HANSEN) (Tables 2 and 3).

TABLE 2
YoFlex ® YF-L02 DA Bacteria
Composition

Bifidobacterium species
Lactobacillus acidophilus
Lactobacillus delbrueckii subsp. bulgaricus
Lactobacillus paracasei
Streptococcus thermophiles

TABLE 3
YoFlex ® YF-L02 DA Performance Specifications

| Performance | Specification |
|---|---|
| pH 4 h, 43° C., 500 U/2500 L Inoculation | 4.8-5.2 |
| tpH 4.60, 43° C., 500 U/2500 L Inoculation, min | ≤452 |
| tpH 4.75, 43° C., 500 U/2500 L Inoculation, min | 256-372 |

### Filtration Methods

In certain aspects, provided herein are filtration methods to generate a non-dairy food product from a fermented plant base. In some embodiments, filtration of a fermented plant base is performed by ultra-filtration. In certain embodiments, centrifugal separation (e.g., using a Q517 dairy separator) is used instead of ultra-filtration.

Ultra-filtration allows salts, sugars, organic acids and smaller peptides to pass through the pores of a semi-permeable membrane, whereas proteins, fats and polysaccharides are retained. Ultra-filtration uses the principles of cross-filtration, which separates different components in a feed stream on the basis of the size and the shape of the micro-particles within it. One example of a membrane used for ultra-filtration is a flat sheet membrane. Flat sheet membranes are made of either polysulphone or polyethersulphone polymer based on a polypropylene (PP) support material, which permits an extended pH and temperature range. Flat sheet membranes are tolerant to high pH and temperature. Flat sheet membranes are available with different flux properties, molecular weight cut-off values, and rejection capabilities. An example of a flat sheet membrane is the Alfa Laval Dairy UF-pHt™-4 flat sheet membrane (e.g., membrane type GR60PP). The recommended operating limits of Alfa Laval Dairy UF-pHt™ flat sheet membranes are listed in Table 4 below.

TABLE 4
Recommended Operating Limits of Alfa Laval Dairy
UF-pHt ™ flat sheet membrane

| | |
|---|---|
| pH Range | 1-13 |
| Typical operating pressure (Bar) | 1-10 |
| Temperature (° C.) | 5-75 |

Another example of membranes used for ultra-filtration are spiral membranes, otherwise known as a ‘spiral filtration system’ or ‘diafiltration system’. Spiral membranes are based on a construction of a polymeric membrane of either polysulphone or polyethersulphone with polyester (PET) or polypropylene (PP) support material, which permits an extended pH and temperature range. Spiral membranes based on polypropylene are tolerant to high pH and temperature. Examples of spiral membranes are Alfa Laval Dairy UF-PET spiral membranes and Alfa Laval Dairy UF-pHt™ spiral membranes. Standard configurations of Alfa Laval Dairy spiral membranes are listed in Table 5. Standard sizes of Alfa Laval Dairy spiral membranes are listed in Table 6. Cross-flow and pressure drop measurements of Alfa Laval Dairy spiral membranes are listed in Table 7. The recommended operating limits of Alfa Laval Dairy spiral membranes are listed in Table 8.

TABLE 5
Standard configurations of Alfa Laval Dairy spiral membranes

| | |
|---|---|
| Spiral Size | Thickness of Feed Spacer (mil) |

Alfa Laval Dairy UF-PET

| | |
|---|---|
| 2517 | 48 |
| 3838 | 48 |
| | 80 |
| 6338 | 30 |
| | 48 |
| | 65 |
| | 80 |
| 8038 | 30 |
| | 48 |
| | 65 |
| | 80 |
| 8338 | 30 |
| | 48 |
| | 65 |
| | 80 |

Alfa Laval Dairy UF-pHt ™

| | |
|---|---|
| 2517 | 48 |
| 2538 | 48 |
| 3838 | 30 |
| | 48 |
| | 80 |
| 6338 | 30 |
| | 48 |
| | 65 |
| | 80 |
| 8038 | 30 |
| | 48 |
| | 65 |
| | 80 |
| 8338 | 30 |
| | 48 |
| | 65 |
| | 80 |

TABLE 6
Standard sizes of Alfa Laval Dairy spiral membranes

| | Outer | | Housing | | Spiral | | ATD socket | | ATD socket | |
|---|---|---|---|---|---|---|---|---|---|---|
| | diameter (OD) | | diameter (HD) | | length (L1) | | diameter (ID) | | depth (L2) | |
| Size | mm | inches | mm | inches | mm | inches | mm | inches | mm | inches |
| 2517 | 64.0-65.0 | 2.52-2.56 | 66.0 | 2.60 | 432 | 17.01 | 21.10 | 0.83 | 50.0 | 1.97 |
| 2538 | 64.0-65.0 | 2.52-2.56 | 66.0 | 2.60 | 965 | 37.99 | 21.10 | 0.83 | 50.0 | 1.97 |
| 3838 | 95.0-96.5 | 3.74-3.80 | 97.55 | 3.84 | 965 | 37.99 | 21.10 | 0.83 | 50.0 | 1.97 |
| 6338 | 160.0-162.0 | 6.30-6.38 | 163.10 | 6.42 | 965 | 37.99 | 28.90 | 1.14 | 76.0 | 2.99 |
| 8038 | 198.5-201.5 | 7.82-7.93 | 204.14 | 8.04 | 965 | 37.99 | 28.90 | 1.14 | 76.0 | 2.99 |
| 8338 | 208.5-210.5 | 8.21-8.29 | 213.10 | 8.34 | 965 | 37.99 | 28.90 | 1.14 | 76.0 | 2.99 |

TABLE 7
Cross-flow and pressure drop measurements
of Alfa Laval Dairy spiral membranes

| | Outer diameter: | | | | | | | | | |
|---|---|---|---|---|---|---|---|---|---|---|
| | | 2.5″ | 3.8″ | | 6.3″ | | 8.0″ | | 8.3″ | |
| Spacer thickness: | m³/h | bar | m³/h | bar | m³/h | bar¹ | m³/h | bar² | m³/h | bar² |
| 30 mil | — | — | 7 | 1.1 | 17 | 1.1 | 19 | 0.9 | 21 | 0.9 |
| 48 mil | 1.5 | 0.5 | 9 | 1.1 | 21 | 1.1 | 23 | 0.9 | 26 | 0.9 |
| 65 mil | — | — | — | — | 25 | 1.1 | 27 | 0.9 | 31 | 0.9 |
| 80 mil | — | — | 13 | 1.1 | 29 | 1.1 | 32 | 0.9 | 36 | 0.9 |

Note:
Calculated at tight fit of spiral membrane and housing by use of standard ATD system
¹During production at <50° C., 1.3 bar 2 During production at <50° C., 1.1 bar
²During production at <50° C., 1.1 bar

TABLE 8
Recommended Operating Limits of
Alfa Laval Dairy spiral membranes

| Production | Dairy UF-PET | Dairy UF-pHt ™ |
|---|---|---|
| pH range (reference temperature | 2-9 | 2-10 |
| Typical operating pressure, bar | <10 | <10 |
| Temperature, ° C. | 5-50 | 5-75 |

In some embodiments, ultra-filtration of the fermented plant base is performed by plate and frame filtration system. Plate and frame filtration system consists of membranes sandwiched between membrane support plates arranged in stacks. The feed material is forced through very narrow channels that may be configured for parallel flow or as a combination of parallel and serial channels.

In some embodiments, ultra-filtration of the fermented plant base is performed by a ceramic filtration system. A ceramic filtration system uses a network of pores on a ceramic surface to filter a liquid.

In some embodiments of the methods provided herein, filtration of a fermented plant base is performed by reverse osmosis.

In certain embodiments of the methods provided herein, filtration of a fermented plant base is performed by centrifugal separation (e.g., using a 0517 dairy separator) instead of by ultra-filtration of the fermented plant base.

### Composition of Non-Dairy Food Product

In certain aspects, provided herein are methods to generate a non-dairy food product. In certain embodiments, the non-dairy food product comprises an increased protein content (e.g., as compared to before it underwent filtration). In some embodiments, the non-dairy food product comprises at least 6% total protein. In some embodiments, the non-dairy food product comprises 6%, 7%, 8%, 9%, 10%, 11%, 12%, or 13% total protein. In some embodiments, the non-dairy food product comprises 7% total protein. The protein content may be measured by Kjeldahl analysis (NF EN ISO 8968-1) as the reference method for the determination of the protein content of dairy products based on measurement of total nitrogen. Nitrogen is multiplied by a factor, typically 6.38 for milk protein, to express the results as total protein: for oat protein a factor of 5.83 is typically used (FAO FOOD AND NUTRITION PAPER 77, Food energy—methods of analysis and conversion factors, Report of a Technical Workshop, Rome, 3-6 Dec. 2002, FOOD AND AGRICULTURE ORGANIZATION OF THE UNITED NATIONS, Rome, 2003). The method is described in both AOAC Method 991.20 (1) and International Dairy Federation Standard (IDF) 20B:1993. Usually the total protein content is known for all the ingredients used to prepare the product, and total protein content is calculated from these data.

In some embodiments, the non-dairy food product comprises no greater than 8% total carbohydrates. In some embodiments, the non-dairy food product comprises about 4%, 5%, 6%, 7%, or 8% total carbohydrates. Suitable assays for measuring carbohydrate concentrations include high-performance liquid chromatography (HPLC) and high-performance anion exchange chromatography with pulsed amperometric detection (HPAEC-PAD). Preferably, HPAEC-PAD will be used. An assay for measuring lactose concentrations includes Association of Official Agricultural Chemists (AOAC) 984.22, which utilizes liquid chromatography (LC) to detect lactose present.

In some embodiments, the non-dairy food product is a yogurt. In some embodiments, the non-dairy food product is a kefir. In some embodiments, the non-dairy food product is intended for human consumption. In some embodiments, the non-dairy food product is an additive or ingredient to other food products.

In some embodiments, the non-dairy food product produced by the methods of the current invention has improved organoleptic properties. In some embodiments, the non-dairy food product has improved taste, e.g., less off-flavor and/or less bitterness.

In some embodiments, partially hydrolyzed plant protein within the non-dairy food product forms gels with similar mechanical strength and water-holding capacity as those from animal proteins. Plant protein gels may provide texture and structure in the non-dairy food product. In some embodiments, the texture of the non-dairy food product is creamy.

In some embodiments, the non-dairy food product is optionally made with stabilizers and or emulsifiers. In some embodiments, the stabilizers and emulsifiers adjust viscosity of the non-dairy food product. In some embodiments the stabilizers and emulsifiers adjust the texture and/or mouthfeel of the non-dairy food product. In some embodiments, the stabilizers are hydrocolloids. Examples of stabilizers include but are not limited to starch, xanthan, guar gum, locust bean gum, gum karaya, gum tragacanth, gum, Arabic and cellulose derivatives, alginate, pectin, carrageenan, gelatin, gellan and agar. Examples of emulsifers include but are not limited to lecithin, mono- and diglycerides, and polysorbates.

In some embodiments, the non-dairy food product is optionally made with added fats and oils. Examples of fats and oils include but are not limited to canola oil, sunflower oil, coconut oil, coconut fat, cocoa fat.

In some embodiments, texture modifiers are used to modify the overall texture or mouthfeel of a food product and include gelling agents (for example: gelatine, agar, carrageenan, pectin, natural gums), stabilizers (for example: agar, pectin, Arabic gum, gelatin), emulsifiers (for example: lecithin, mono- and di-glycerides of fatty acids (E471), polysorbates, canola oil), esters of mono and di-glycerides of fatty acid (E472a-f)), and thickeners (for example: guar gum, xanthan gum, pectin, agar, carrageenan, alginic acid).

In some embodiments of the methods provided herein, the texture of the non-dairy food product may be analyzed with a Texture Analyzer, such as the CT3™ Texture Analyzer (AMETEK Brookfield) (Table 9).

TABLE 9
Specifications of CT3 ™ Texture Analyzer
All CT3 Model Specifications
Speed:

| | |
|---|---|
| Range | 0.01-0.1 mm/s (increments of 0.01 mm/s) |
| | 0.1-10 mm/s (increments of 0.1 mm/s) |
| Accuracy | ±0.1% of set speed |

Position:

| | | |
|---|---|---|
| Range | 0-101.6 | mm |
| Resolution | 0.1 | mm |
| Accuracy | 0.1 | mm |

In some embodiments of the methods provided herein, the moisture of the non-dairy food product may be analyzed with an Electronic Moisture Analyzer, such as a Moisture Analyzer DBS (Kem).

In some embodiments of the methods provided herein, the refractive index of the non-dairy food product may be analyzed with a refractometer, such as a Digital Hand-Held “Pocket” Refractometer (PAL).

In some embodiments, the non-dairy food product can be optionally fortified with extraneous protein, a mineral source, a vitamin source, a carbohydrate source or a mixture. Examples of fortifying sources include sources of calcium, vitamin D and sources of protein. The extraneous protein may be from an animal source or plant source. The extraneous protein source may be selected from a variety of materials, including without limitation, milk protein, whey protein, caseinate, soy protein, egg whites, gelatins, collagen and combinations thereof.

In some embodiments, the non-dairy food product can be blended with natural or artificial flavoring ingredients. For example, the non-dairy food product can be blended with fruit, nuts, or seeds. Such ingredients may be combined with the compositions to form a substantially uniform flavored product or may be present in a non-uniform manner, such as fruit on the bottom of the composition. Non-limiting examples of flavored compositions include chocolate, strawberry, peach, raspberry, vanilla, banana, coffee, mocha and combinations thereof.

In some embodiments, the viscosity of the non-dairy food product is from 100 cP to 200 cP, from 50 cP to 100 cP, from 25 cP to 50 cP, or from 10 cP to 25 cP. Viscosity may be measured with a Brookfield Visco DV-II+ instrument

### EXAMPLES

### Example 1: Preparation of a Fermented Edible Product Made from Oat Milk with Pre-Filtration Step

Purpose: to create a fermented edible product, made from oats, with optional fortification of plant protein, without the addition ofany stabilizers such as gellan gum starch/pectin/agar agar/etc. etc. Protocol involves pre-filtration step.

TABLE 10
Exemplary Protocol

| Step | Content/Procedure | Notes |
|---|---|---|
| 1 | Oat Milk | A concentrated oat milk typically |
| | Protein e.g. 1-4% | contains bitter compounds, some of which |
| | Enzymatic treatment with amylase | are small peptides, others can include |
| | and/or betaglucanase (optional) | lipid oxidation and/or lipid degradation |
| | | products. Enzymatic treatment with |
| | | amylase enzyme can help increase the |
| | | glucose or maltose content to facilitate |
| | | fermentation by lactic acid bacteria. |
| | | Enzymatic treatment with betaglucanase |
| | | can increase the efficiency of the ultra- |
| | | filtration step(s). |
| 2 | Add Water | Adding water dilutes the concentrated oat |
| | Protein e.g. 0.5%-1.5% | milk so that we can wash out |
| | Carbohydrates e.g. 4-8% | carbohydrates as well as small (bitter) |
| | Enzymatic treatment with amylase | peptides (e.g. <3 kDa). Enzymatic |
| | and/or betaglucanase (optional) | treatment with amylase enzyme can help |
| | | increase the glucose or maltose content to |
| | | facilitate fermentation by lactic acid |
| | | bacteria. Enzymatic treatment with |
| | | betaglucanase can increase the efficiency |
| | | of the ultra-filtration step(s). |
| 3 | Ultra-filtration | Ultra-filtration washes out carbohydrates |
| | E.g. spiral ultra-filtration | as well as small (bitter) peptides (e.g. <3 |
| | Protein e.g. 2-4% | kDa) and increases the protein content. |
| | Membrane pore size e.g. 5-25 kDa | You need a minimum total (crude) protein |
| | | content of 2.5% in order to ferment it and |
| | | create a gel. |
| 4 | Protein fortification (optional) | Homogenization reduces the particle size |
| | E.g. pea protein hydrolysate | of fat and protein structures so that the |
| | Homogenization (optional) | finished product has a smooth texture. It |
| | E.g. 350 Mpa | increases the shelf life of the finished |
| | | product by killing yeast and mold and |
| | | bacteria. |
| 5 | Pasteurization | Pasteurization increases the shelf life of |
| | E.g. 5 minutes at 90 C. | the finished product by killing yeast and |
| | | mold and bacteria. |
| 6 | Fermentation with (probiotic) lactic | Fermentation (e.g. with YoFlex YF-L02 |
| | acid cultures | DA from Chr. Hansen) increases the shelf |
| | | life of the finished product by reducing |
| | | the pH. It also helps build texture and |
| | | gives the finished product a fresh taste. |
| | Transglutaminase enzyme | Transglutaminase enzyme (e.g. Probind |
| | (optional) | CH 2.0 from BDF) helps cross-link |
| | Exopeptidase enzyme (optional) | proteins and thereby helps build texture. |
| | Amylase enzyme (optional) | Transglutaminase also links small (bitter) |
| | E.g. <6 hours at 35-45 C. | peptides to larger protein structures, |
| | E.g. pH ~4.65 | thereby “debittering” the finished product. |
| | | An optional exopeptidase enzyme (e.g. |
| | | Flavorpro 937 MDP from Biocatalysts) |
| | | can be added to help further reduce |
| | | bitterness. Use of an amylase enzyme |
| | | (optional) is to increase sugar content |
| | | and/or reduce starch content; the latter is |
| | | useful for treatment of fermented base |
| | | with ultra-filtration equipment. |
| 7 | Cooling | Cooling helps to minimize post |
| | E.g. <20 C. within 60 minutes | acidification, once the target pH has been |
| | | reach. |
| 8 | Ultra-Filtration | Ultra-filtration helps to increase the |
| | E.g. plate & frame ultra-filtration | protein content, reduce carbohydrate |
| | Membrane pore size e.g. 5-25 kDa | content, reduce bitterness, reduce |
| | Protein e.g. 5-11% | viscosity (creating a thicker product), |
| | | increase texture and increase smoothness. |
| | | Plate & Frame UF unit can be purchased |
| | | from e.g. Tetra Pak. |
| 9 | Cooling | Cooling helps to minimize post |
| | E.g. <10 C. within 60 minutes | acidification, once the target pH has been |
| | | reach. |
| 10 | Blending with flavors, nuts, seeds, | |
| | etc. | |
| | E.g. strawberry fruit preparation or | |
| | walnuts or oatmeal | |
| 11 | Filling & sealing & packaging | |
| | E.g. using 150 gram cups | |
| 12 | Refrigeration | |
| | E.g. <4 C. | |

### Example 2: Preparation of a Made from Oat Milk without Pre-Filtration Step

Purpose: to create a fermented edible product, made from oats, with optional fortification of plant protein, without the addition of any stabilizers such as gellan gum/starch/pectin/agar agar/etc. etc. Protocol is performed without pre-filtration step.

TABLE 11
Exemplary Protocol

| Step | Content/Procedure | Notes |
|---|---|---|
| 1 | Oat Milk | Oat Milk needs to have a minimum of 2.5% |
| | Protein e.g. 2.5-4% | total (crude) protein (from oats or from added |
| | Enzymatic treatment with amylase | plant protein, such as added oat protein or |
| | and/or betaglucanase (optional) | added pea protein hydrolysate) |
| | | Enzymatic treatment with amylase enzyme can |
| | | help increase the glucose or maltose content to |
| | | facilitate fermentation by lactic acid bacteria. |
| | | Enzymatic treatment with betaglucanase can |
| | | increase the efficiency of the ultra-filtration |
| | | step(s). |
| 2 | Protein fortification (optional) | Homogenization reduces the particle size of fat |
| | E.g. pea protein hydrolysate | and protein structures so that the finished |
| | Homogenization (optional) | product has a smooth texture. It increases the |
| | E.g. 350 Mpa | shelf life of the finished product by killing |
| | | yeast and mold and bacteria. |
| 3 | Pasteurization | Pasteurization increases the shelf life of the |
| | E.g. 5 minutes at 90 C. | finished product by killing yeast and mold and |
| | | bacteria. |
| 4 | Fermentation with (probiotic) lactic | Fermentation (e.g. with YoFlex YF-L02 DA |
| | acid cultures | from Chr. Hansen) increases the shelf life of |
| | Transglutaminase enzyme (optional) | the finished product by reducing the pH. It also |
| | Exopeptidase enzyme (optional) | helps build texture and gives the finished |
| | Amylase enzyme (optional) | product a fresh taste. Transglutaminase |
| | E.g. <6 hours at 35-45 C. | enzyme (e.g. Probind CH 2.0 from BDF) helps |
| | E.g. pH ~4.65 | cross-link proteins and thereby helps build |
| | | texture. Transglutaminase also links small |
| | | (bitter) peptides to larger protein structures, |
| | | thereby “debittering” the finished product. An |
| | | optional exopeptidase enzyme (e.g. Flavorpro |
| | | 937 MDP from Biocatalysts) can be added to |
| | | help further reduce bitterness. If the plant |
| | | protein has been added in step 1, a |
| | | transglutaminase enzyme will not be used. Use |
| | | of an amylase enzyme (optional) is to increase |
| | | sugar content and/or reduce starch content; the |
| | | latter is useful for treatment of fermented base |
| | | with ultra-filtration equipment. |
| 5 | Cooling | Cooling helps to minimize post acidification, |
| | E.g. <20 C. within 60 minutes | once the target pH has been reach. |
| 6 | Ultra-filtration | Ultra-filtration helps to increase the protein |
| | E.g. plate & frame ultra-filtration | content, reduce carbohydrate content, reduce |
| | Membrane pore size e.g. 5-25 kDa | bitterness, reduce viscosity (creating a thicker |
| | Protein e.g. 5-11% | product), increase texture and increase |
| | | smoothness. Plate & Frame UF unit can be |
| | | purchased from e.g. Tetra Pak. |
| 7 | Cooling | Cooling helps to minimize post acidification, |
| | E.g. <10 C. within 60 minutes | once the target pH has been reach. |
| 8 | Blending with flavors, nuts, seeds, etc. | |
| | E.g. strawberry fruit preparation or | |
| | walnuts or oatmeal | |
| 9 | Filling & sealing & packaging | |
| | E.g. using 150 gram cups | |
| 10 | Refrigeration | |
| | E.g. <4 C. | |

### Example 3: Ultra-filtration Options

Membrane Modules

Tubular Module:
18×12.5 mm perforated stainless steel tubes
Tubes assembled in a shell-and-tube like construction and connected in series.
A replaceable membrane insert tube is fitted inside each of the perforated stainless steel pressure support tubes.
Permeate is collected on the outside of the tube bundle in the stainless steel shroud.
In tubular module with ceramic membrane, the filter element is a ceramic filter. The thin walls of the channels are made of fine-grained ceramic and constitute the membrane. The support material is coarse grained ceramic.

Hollow Fiber:
Cartridges each having bundles of 45 to over 3000 hollow-fiber elements.
The fibers are oriented in parallel.
Fibers are potted in a resin at their ends and enclosed in the permeate-collecting-tube of epoxy.
The membrane has an inner diameter ranging from 0.5 to 2.7 mm.
The active membrane surface is on the inside of the hollow fiber.
The outside of the hollow-fiber wall, has a rough structure and acts as a supporting structure for the membrane.
The feed stream flows through the inside of these fibers, and permeate is collected outside and removed at the top of the tube.

Spiral Wound:
Contains one or more membrane envelopes, each of which contains two layers of membrane separated by a porous permeate conductive material.
Permeate channel spacer allows the permeate passing through the membrane to flow freely.
The two layers of membrane with the permeate channel spacer between them are sealed with adhesive at two edges and one end to form the membrane envelope.
The open end of the envelope is connected and sealed to a perforated permeate collecting tube.
The feed channel spacer is placed in contact with one side of each membrane envelope.

Plate and Frame Design:
Consist of membranes sandwiched between membrane support plates arranged in stacks.
The feed material is forced through very narrow channels that may be configured for parallel flow or as a combination of parallel and serial channels.

### Example 4: Final Composition of Fermented Edible Product

TABLE 12
Composition of exemplary final product

| | |
|---|---|
| Protein | 5-12% |
| Carbohydrates | 4-8% |
| Sugars | 2-5% |

### Example 5: Study Results of Skyr-Style Oat-Based Yogurt

The primary objective of this study is to provide a fermented “spoonable” plant-based product that is high in protein content. This study uses a combination of filtration processes to reduce carbohydrates and increase protein and fat content that are the key ingredients.

Today, many plant-based protein powders are commercially available. They can be added to a liquid plant base to increase protein content and they can also be used as raw material for non-dairy yogurt. This often requires the use of a stabilizer to get desired texture. Additionally, fortification with protein powders produces a product with an undesired mouthfeel and poor taste. The study aims to achieve a smooth viscous texture without the use of stabilizers.

Traditionally, thermo-related processes are used to make Greek style dairy product, which adapts Quark manufacturing process and centrifugal separators. A separator is also used to produce a plant-base product that is high in protein. A disadvantage of using a separator is that the protein yield is less and heat treatment kills the active culture. This study reduces the protein loss, gives a better yield, and increases the amount of active culture in the final product. From this study, it is possible to maintain raw material characteristics and make a fermented “spoonable” product. This study also makes it possible to create a single plant ingredient product from a fresh soluble plant-based ingredient. It is also possible to reduce bitterness by adding an enzyme normally used to develop greater product thickness. To develop the product, the study mainly used a small 100 l/hour pilot pasteurizer, a pilot spiral membrane filtration unit, a pilot plate & frame membrane filtration unit, and fermentation vats.

TABLE 13
Study Results

| P&F date | 21-Jan | | 22-Jan | | 23-Jan |
|---|---|---|---|---|---|
| Base | Frulact LS | | Frulact LS | | Frulact LS |
| Trial run goals | Test if it's possible | | Stop pH to get a | | Reference Frulact w/ |
| | to have DF but non | | milder product | | PB to compare with |
| | spiral | | | | Ajinomoto |
| Water | 65% | | 65% | | 55% |
| Spiral membrane | 10 | kDa | 10 | kDa | NON SPIRAL |
| Spiral spacer | 30 | mil | 30 | mil | |
| Protein sprint | | | | | 1.6% |
| TS [/brix] | 8.33% | | | | 10.79% |
| Enzyme type (1) | 0.05% PB | | 0.05% PB | | 0.03% PB |
| Enzyme type (2) | | | | | |
| Bacteria | | | | | 0.02% YF-L02-DA |
| Fermentation time [hh:mm] | Overnight | | 6:30 | | Overnight |
| Remarks | | | | | Gel structure but |
| | | | | | could easily break up |
| | | | | | by hand + process. |
| pH | 4.09 | | 4.47 | | 4.08 |
| P&F filtration | 20 | kDa | 20 | kDa | 20 kDa |
| Concentration Ratio [x] | 4.1 | | 2.4 | | 4.7 |
| Feed flow [L/h] | 164 | | 224 | | 141 |
| Loop flow | 36.4 | | 36.26 | | 35 |
| Protein | | | | | |
| TS | 18.79% | | 17.79% | | 18.90% |
| % P/TS | | | | | |
| 24 hour Peak Load [g] | 199 | | | | |
| Remarks | | | Low ratio and | | P&F feed flow 141 |
| | | | great capacity | | L/h |
| Assumptions | | | | | |
| Possible future tests | | | | | |
| BSG | | | | | |

| P&F date | 29-Jan | 4-Feb | |
|---|---|---|---|
| Base | Frulact LS | Yosoy | |
| Trial run goals | Try Ajinomoto enzymes | Try Yosoy as | |
| | | comparison with | |
| | | Frulact | |
| Water | 55% | 0% | |
| Spiral membrane | NON SPIRAL | 10 | kDa |
| Spiral spacer | | 30 | mil |
| Protein sprint | 1.6% | | |
| TS [/brix] | 10.56% | 14.20% | |
| Enzyme type (1) | 0.02% Activa Ti | 0.05% PB | |
| Enzyme type (2) | 0.02% Activa SYG | | |
| Bacteria | 0.02% YF-L02-DA | 0.02% YF-L02-DA | |
| Fermentation time [hh:mm] | | | |
| Remarks | | | |
| pH | 4.46 | 4.48 | |
| P&F filtration | 20 kDa | 20 | kDa |
| Concentration Ratio [x] | 4.6 | 2.43 | |
| Feed flow [L/h] | 112 | 135 | |
| Loop flow | 36.7 | 38.4 | |
| Protein | 6.0% | | |
| TS | 19.90% | 19.10% | |
| % P/TS | 30.15% | | |
| 24 hour Peak Load [g] | 168 | 216 | |
| Remarks | Need to run P&F at high ration to | Great product thin out | |
| | increase protein | of P&F but gels over | |
| | | time. | |
| Assumptions | Higher pH => lower feed flow | | |
| Possible future tests | | Yosoy currently not | |
| | | available and very | |
| | | expensive | |
| BSG | | | |

| P&F date | 5-Feb | 11-Feb |
|---|---|---|
| Base | Frulact LS | Yosoy |
| Trial run goals | Try higher degree of DF | Make more of Yosoy |
| | | that is best so far |
| Water | 75% | 0% |

| | | | | |
|---|---|---|---|---|
| Spiral membrane | 10 | kDa | 10 | kDa |
| Spiral spacer | 30 | mil | 30 | mil |
| Protein sprint | | | | |

| | | |
|---|---|---|
| TS [/brix] | 10.30% | 14.40% |
| Enzyme type (1) | 0.05% PB | 0.05% PB |

| | |
|---|---|
| Enzyme type (2) | Undiluted base treated with |
| | CGL at 65° C. for 2.5 hours |

| | | |
|---|---|---|
| Bacteria | 0.02% YF-L02-DA | 0.02% YF-L02-DA |

Fermentation time [hh:mm]

| | |
|---|---|
| Remarks | Firm base |

| | | |
|---|---|---|
| pH | 4.38 | Mild [4.5] |

| | | | | |
|---|---|---|---|---|
| P&F filtration | 20 | kDa | 20 | kDa |

| Concentration Ratio [x] | 4.64 | 2.4 |
|---|---|---|
| Feed flow [L/h] | 122 | 151 |
| Loop flow | 35.4 | 37.4 |
| Protein | | 6.27% |
| TS | 20.03% | 20.70% |
| % P/TS | | 30.29% |
| 24 hour Peak Load [g] | | 225 |

| | | |
|---|---|---|
| Remarks | Extra sweetness but it | Stabil and rapid P&F run. |
| | brings out bitterness | Best product so far, well |
| | | balanced and thick. Thickens |
| | | more over time. |

Assumptions
Possible future tests
BSG

| P&F date | 19-Feb | | 26-Feb | |
|---|---|---|---|---|
| Base | Yosoy | | Yosoy | |
| Trial run goals | Repeat Feb 11 w/bigger | | Reference Yosoy with No | |
| | spiral and higher protein | | probind and higher protein | |
| Water | 0% | | 0% | |
| Spiral membrane | GR60PE-6334/48 20 kDa | | 20 | kDa |
| | installed Feb 14 | | | |
| Spiral spacer | 48 | mil | 48 | mil |
| Protein sprint | 3.0% | | 2.80% | |
| TS [/brix] | 15.50% | | 15.30% | |
| Enzyme type (1) | 0.05% PB | | — | |
| Enzyme type (2) | | | | |
| Bacteria | 0.02% YF-L02-DA | | 0.02% YF-L02-DA | |
| Fermentation time [hh:mm] | | | | |
| Remarks | | | Great looking and smooth | |
| | | | texture - thinner without | |
| | | | probind | |
| pH | 4.56 | | Mild [4.5] | |
| P&F filtration | 20 | kDa | 20 | kDa |
| Concentration Ratio [x] | 2.74 | | 3.14 | |
| Feed flow [L/h] | 112 | | 97 | |
| Loop flow | 35.2 | | 36.6 | |
| Protein | 7.82% | | 7.60% | |
| TS | 25.66% | | 24.20% | |
| % P/TS | 30% | | 31% | |
| 24 hour Peak Load [g] | | | 181 | |
| Remarks | Stabil P&F run. Very thick | | | |
| | and gelled over time | | | |
| Assumptions | | | | |
| Possible future tests | | | | |

| | |
|---|---|
| BSG | Good taste, thick probably |
| | too thick, thickness damps |
| | taste a bit |

| P&F date | 26-Feb | | 4-Mar | |
|---|---|---|---|---|
| Base | Yosoy | | Frulact LB | |
| Trial run goals | Test P&F flow for | | New Low Bitter Frulact | |
| | a low pH | | base - Reference spiral no PB | |
| Water | 0% | | | |
| Spiral membrane | 20 | kDa | 20 | kDa |
| Spiral spacer | 48 | mil | 48 | mil |
| Protein sprint | 2.84% | | 3.10% | |
| TS [/brix] | 15.30% | | 10.95% | |
| Enzyme type (1) | 0.05% PB | | — | |
| Enzyme type (2) | | | | |
| Bacteria | 0.02% YF-L02-DA | | 0.02% YF-L02-DA | |
| Fermentation time [hh:mm] | | | 5:55 | |
| Remarks | Firm base | | | |
| pH | 3.96 | | | |
| P&F filtration | 20 | kDa | 20 | kDa |
| Concentration Ratio [x] | 2.77 | | 2.5 | |
| Feed flow [L/h] | 131 | | 95 | |
| Loop flow | 36.65 | | 39.14 | |
| Protein | 6.50% | | 7.03% | |
| TS | 22.83% | | 18.40% | |
| % P/TS | 28% | | 38% | |
| 24 hour Peak Load [g] | 255 | | 49 | |
| Remarks | Starting P&F feed | | Fermented base thin - Stabil | |
| | flow 131 L/h | | run - P&F easy to clean | |
| Assumptions | P&F flow only slightly | | | |
| | better, better to focus | | | |
| | on milder pH | | | |
| Possible future tests | | | | |

| | | |
|---|---|---|
| BSG | Too sour, not a | Too thin, long fermentation |
| | good sour taste | |

| P&F date | 6-Mar | | 13-Mar |
|---|---|---|---|
| Base | Frulact LB | | SunOpta |
| Trial run goals | Test new base w/ | | Try standard procedure on |
| | spiral and PB | | new base no probind as |
| | | | reference |
| Water | | | 76% |
| Spiral membrane | 20 | kDa | GR70PE-6338 10 kDa |
| | | | Installed March 11t |
| Spiral spacer | 48 | mil | 48 mil (previously |
| | | | we used 30 mil) |
| Protein sprint | 2.99% | | 2.38% |
| TS [/brix] | 10.40% | | 22.50% |
| Enzyme type (1) | 0.05% PB | | — |
| Enzyme type (2) | | | |
| Bacteria | 0.02% YF-L02-DA | | 0.02% YF-L02-DA |
| Fermentation time [hh:mm] | 6:00 | | 5:00 |
| Remarks | | | Thin base |
| pH | | | 4.59 |
| P&F filtration | 20 | kDa | 20 kDa |
| Concentration Ratio [x] | 2.7 | | 2.75 |
| Feed flow [L/h] | 108 | | 29 |
| Loop flow | 38.9 | | 38 |
| Protein | 7.20% | | 6.20% |
| TS | 17.55% | | 38.12% |
| % P/TS | 41% | | 16% |
| 24 hour Peak Load [g] | 59 | | 55 |
| Remarks | Smooth run in spiral and | | Not possible to P&F. |
| | P&F. Texture and body | | High solids. |
| | lacking, perhaps partly | | |
| | because it needs more | | |
| | protein and solids. | | |
| Assumptions | | | Carbs are also concentrated |
| | | | in spiral and P&F. |
| Possible future tests | | | |

| | | |
|---|---|---|
| BSG | Too thin, long fermentation | Too thin, longer |
| | | fermentation |

| P&F date | 13-Mar | | 24-Mar | |
|---|---|---|---|---|
| Base | SunOpta | | Yosoy | |
| Trial run goals | New base standard | | Repeat previous Yosoy trials | |
| | procedure w/probind | | with a new batch of Yosoy | |
| Water | 76% | | 0% | |
| Spiral membrane | 10 | kDa | 10 | kDa |
| Spiral spacer | 48 | mil | 48 | mil |
| Protein sprint | 2.33% | | 3.20% | |
| TS [/brix] | 22.40% | | 15.40% | |
| Enzyme type (1) | 0.05% PB | | 0.05% PB | |
| Enzyme type (2) | | | | |
| Bacteria | 0.02% YF-L02-DA | | 0.02% YF-L02-DA | |
| Fermentation time [hh:mm] | 5:15 | | | |
| Remarks | Thin base | | Firm fermented base | |
| pH | Mild 4.5 | | 4.53 | |
| P&F filtration | 20 | kDa | 20 | kDa |
| Concentration Ratio [x] | Error | | 2.4 | |
| Feed flow [L/h] | 22 | | 123 | |
| Loop flow | 37.8 | | ? | |
| Protein | 5.71% | | 6.19% | |
| TS | 36.99% | | 22.10% | |
| % P/TS | 15% | | 28% | |
| 24 hour Peak Load [g] | 63 | | 289 | |
| Remarks | Not possible to P&F. High | | Great tasting product | |
| | solids. Minor difference | | texture very firm | |
| | with probind | | | |
| Assumptions | Carbs are also concentrated | | | |
| | in spiral and P&F. | | | |
| Possible future tests | | | | |

| | |
|---|---|
| BSG | Too thin, longer |
| | fermentation |

| P&F date | 2-Apr | 20-Apr | 22-Apr |
|---|---|---|---|
| Base | Frulact LB | SunOpta | SunOpta |
| Trial run goals | Evaluate bitterness | SunOpta reference | Test if CGL helps |
| | in non diafiltrated | | with P&F |
| | LB base | | separation |
| Water | 0% | 76% | 76% |
| Spiral membrane | NON-SPIRAL | GR82PP-6338 5 | 5 kDa (in bath |
| | | kDa | May 5th) |

| | | | | | |
|---|---|---|---|---|---|
| Spiral spacer | — | 30 | mil | 30 | mil |

| Protein sprint | 3.51% | 1.4% | 1.4% |
|---|---|---|---|
| TS [/brix] | | 16.5% | 16.5% |
| Enzyme type (1) | 0.05% PB | 0.05% PB | 0.05% PB |
| Enzyme type (2) | | | 0.05% CGL |

| | | | |
|---|---|---|---|
| Bacteria | 0.02% YF-L02- | 0.02% YF-L02- | 0.02% YF-L02- |
| | DA | DA | DA |
| Fermentation time [hh:mm] | 4:11 | 2:51 | 2:40 |
| Remarks | | Liquid base | Liquid base |
| pH | 4.55 | Mild 4.5 | Mild 4.5 |

| | | | | | |
|---|---|---|---|---|---|
| P&F filtration | 20 kDa | 20 | kDa | 20 | kDa |

| | | | |
|---|---|---|---|
| Concentration Ratio [x] | 2.2 | 2.4? | 4.1? |
| Feed flow [L/h] | 101 | <30 | <30 |

| | |
|---|---|
| Loop flow | 38.8 |

| | | | |
|---|---|---|---|
| Protein | 6.40% | 3.96% | 4.86% |
| TS | 27.13% | 26.20% | 25.30% |
| % P/TS | 24% | 15% | 19% |
| 24 hour Peak Load [g] | 113 | <30 | <30 |
| Remarks | Very smooth texture | Difficult to spiral | Difficult to spiral |
| | but thin and sweet. | and P&F - low | and P&F - Low |
| | | protein as part of | protein as part of |
| | | solids | solids. |
| Assumptions | Smooth run, but | Need to break | Using CGL helps |
| | carbs are high | down starch before | to reduce solids. |
| | | spiral filtration | |

| | |
|---|---|
| Possible future tests | Reduce carbs with |
| | spiral |
| BSG | |

| P&F date | 8-May | | 13-May | |
|---|---|---|---|---|
| Base | SunOpta | | Frulact LB | |
| Trial run goals | Test if CGL before spiral | | Try to improve fermentation | |
| | will help to reduce carbs | | from 4 and 6th of March | |
| | and get better texture | | with more carbs | |
| Water | 77% | | 50% | |
| Spiral membrane | GR60PP-633820 kDa | | 20 | kDa |
| | installed April 6th | | | |
| Spiral spacer | 48 | mil | 48 | mil |
| Protein sprint | 3% | | 3.40% | |
| TS [/brix] | 19.84% | | 17.6° Brix | |
| Enzyme type (1) | 0.05% PB | | X | |
| Enzyme type (2) | | | X | |
| Bacteria | 0.02% YF-L02-DA | | X | |
| Fermentation time [hh:mm] | 2:52 | | X | |
| Remarks | Liquid base | | X | |
| pH | Mild 4.5 | | X | |
| P&F filtration | 20 | kDa | X | |
| Concentration Ratio [x] | 2.5 | | X | |
| Feed flow [L/h] | 23 | | X | |
| Loop flow | 38.5 | | X | |
| Protein | 6.14% | | X | |
| TS | 29.84% | | X | |
| % P/TS | 21% | | X | |
| 24 hour Peak Load [g] | 42 | | X | |
| Remarks | Now able to make product | | Could not use milk. pH | |
| | but it thin and has | | dropped and milk clotted | |
| | undesirable after taste. | | after 3 days from spiral. | |
| Assumptions | | | | |
| Possible future tests | | | | |
| BSG | | | | |

### INCORPORATION BY REFERENCE

All publications patent applications mentioned herein are hereby incorporated by reference in their entirety as if each individual publication or patent application was specifically and individually indicated to be incorporated by reference. In case of conflict, the present application, including any definitions herein, will control.

### EQUIVALENTS

Those skilled in the art will recognize, or be able to ascertain using no more than routine experimentation, many equivalents to the specific embodiments of the invention described herein. Such equivalents are intended to be encompassed by the following claims.

We claim:

1. A method of producing a plant-based food product comprising the steps of;
(a) adding lactic acid bacteria and optionally enzymes to the plant base comprising no less than 3% total protein;
(b) fermenting the plant base to generate a fermented plant base; and
(c) concentrating the fermented plant base by ultra-filtration to generate a non-dairy food product comprising an increased total protein content compared to the fermented plant base.

2. The method of claim 1, wherein the non-dairy food product comprises as least 6% total protein.

3. The method of claim 1 or claim 2, further comprising pasteurizing the plant base prior to step (a).

4. The method of claim 3, wherein the plant base is pasteurized at 85-95° C.

5. The method of any one of claims 3 to 4, wherein the plant base is pasteurized for 3-7 minutes.

6. The method of claim 1 to 5, further comprising homogenizing the plant base prior to step (a).

7. The method of claim 6, wherein the plant base is homogenized at 300-400 MPa.

8. The method of any one of claims 1 to 7, wherein an extraneous protein is added to the plant base.

9. The method of claim 8, wherein the extraneous protein is added to the plant base prior to step (a).

10. The method of claim 8 or claim 9, wherein the extraneous protein is sourced from an animal or a plant.

11. The method of any one of claims 1 to 10, wherein the enzymes comprise transglutaminase, exopeptidase, and/or amylase.

12. The method of any one of claims 1 to 11, wherein probiotic bacteria are added to the plant base.

13. The method of any one of claims 1 to 12, wherein yeast and/or mold are added to the plant base.

14. The method of any one of claims 1 to 13, wherein the plant base comprises about 3-4% total protein.

15. The method of any one of claims 1 to 13, wherein the plant base comprises about 3.5% total protein.

16. The method of any one of claims 1 to 15, wherein the plant base is fermented during step (b) at 40-46° C.

17. The method of claim 16, wherein the plant base is fermented during step (b) at 43° C.

18. The method of any one of claims 1 to 17, wherein the plant base is fermented for at least 3 hours.

19. The method of any one of claims 1 to 18, wherein the fermented plant base has a pH of about 4-5.

20. The method of any one of claims 1 to 19, wherein the ultra-filtration is performed using a plate and frame filtration system, a spiral filtration system, or a ceramic filtration system.

21. The method of any one of claims 1 to 20, wherein the non-dairy food product comprises about 6-12% total protein.

22. The method of claim 21, wherein the non-dairy food product comprises about 7% total protein.

23. The method of any one of claims 1 to 22, wherein the non-dairy food product comprises no greater than 8% total carbohydrates.

24. The method of any one of claims 1 to 23, wherein the non-dairy food product comprises no greater than 5% total carbohydrates.

25. The method of any one of claims 1 to 24, wherein the non-dairy food product does not comprises an extraneous stabilizer and/or an emulsifier

26. The method of any one of claims 1 to 25, wherein the non-dairy food product comprises a creamy texture.

27. The method of any one claim 1 to 26, wherein the plant base is an oat base.

28. The method of claim 27, wherein the oat base is an aqueous oat base.

29. The method of claim 27 or 28, wherein the aqueous oat base is oat milk.

30. A method of producing a plant-based food product comprising the steps of:
(a) concentrating a plant base comprising less than 1% total protein to produce a concentrated plant base comprising at least 3% total protein.
(b) adding lactic acid bacteria and optionally enzymes to the concentrated plant base;
(c) fermenting the pre-concentrated plant base to generate a fermented plant base; and
(d) concentrating the fermented plant base by ultra-filtration to generate a non-dairy food product comprising an increased total protein content compared to the fermented plant base.

31. The method of claim 30, wherein the non-dairy food product comprises at least 6% total protein.

32. The method of claim 30 or 31, further comprising pasteurizing the plant base prior to step (a).

33. The method of claim 32, wherein the plant base is pasteurized at 85-95° C.

34. The method of any one of claim 32 or 33, wherein the plant base is pasteurized for 3-7 minutes.

35. The method of claim 30 to 34, further comprising homogenizing the plant base prior to step (a).

36. The method of claim 34 or 35, wherein the plant base is homogenized at 300-400 MPa.

37. The method of any one of claims 30 to 36, wherein an extraneous protein is added to the plant base.

38. The method of claim 37, wherein the extraneous protein is added to the plant base prior to step (a).

39. The method of claim 37 or 38, wherein the extraneous protein is sourced from an animal or a plant.

40. The method of any one of claims 30 to 39, wherein the enzymes comprise transglutaminase, exopeptidase, and/or amylase.

41. The method of any one of claims 30 to 40, wherein probiotic bacteria are added to the plant base.

42. The method of any one of claims 30 to 41, wherein yeast and/or mold are optionally added to the plant base.

43. The method of any one of claims 30 to 42, wherein the plant base is concentrated during step (a) by ultra-filtration or reverse-osmosis.

44. The method of any one of claims 30 to 43, wherein the ultra-filtration is performed using a plate and frame filtration system, a spiral filtration system, or a ceramic filtration system.

45. The method of any one of claims 30 to 44, wherein the concentrated plant base comprises about 3-4% total protein.

46. The method of claim 45, wherein the concentrated plant base comprises about 3.5% total protein.

47. The method of any one of claims 30 to 46, wherein the pre-concentrated plant base is fermented during step (b) at 40-46° C.

48. The method of claim 47, wherein the pre-concentrated plant base is fermented during step (b) at 43° C.

49. The method of any one of claims 30 to 48, wherein the pre-concentrated plant base is fermented for at least 3 hours.

50. The method of any one of claims 30 to 49, wherein the fermented plant base has a pH of about 4-5.

51. The method of any one of claims 30 to 50, wherein the non-dairy food product comprises about 6-12% total protein.

52. The method of claim 51, wherein the non-dairy food product comprises about 7% total protein.

53. The method of any one of claims 30 to 52, wherein the non-dairy food product comprises no greater than 8% total carbohydrates.

54. The method of any one of claims 30 to 53, wherein the non-dairy food product comprises no greater than 5% total carbohydrates.

55. The method of any one of claims 30 to 54, wherein the non-dairy food product does not comprise a stabilizer and/or an emulsifier.

56. The method of any one of claims 30 to 55, wherein the non-dairy food product comprises a creamy texture.

57. The method of any one claim 30 to 56, wherein the plant base is an oat base.

58. The method of claim 57, wherein the oat base is an aqueous oat base.

59. The method of claim 57 or 58, wherein the aqueous oat base is oat milk.

60. The method of any one of claims 30 to 59, wherein the non-dairy food product does not comprise extraneous protein.

61. A method of producing a plant-based food product, comprising the steps of:
(a) diluting a concentrated plant base comprising greater than 1% total protein to form a diluted plant base comprising about 1% total protein.
(b) concentrating the diluted plant base to produce a re-concentrated plant base comprising at least 3% total protein.
(c) adding lactic acid bacteria and optionally a plurality of enzymes to the re-concentrated plant base;
(d) fermenting the re-concentrated plant base to generate a fermented plant base; and
(e) concentrating the fermented plant base by ultra-filtration to generate a non-dairy food product comprising an increased total protein content compared to the fermented plant base.

62. The method of claim 61, wherein the non-dairy food product comprises at least 6% total protein.

63. The method of claim 61 or 62, further comprising pasteurizing the plant base prior to step (a).

64. The method of claim 63, wherein the plant base is pasteurized at 85-95° C.

65. The method of any one of claim 63 or 64, wherein the plant base is pasteurized for 3-7 minutes.

66. The method of claim 62 to 65, further comprising homogenizing the plant base prior to step (a).

67. The method of claim 66, wherein the plant base is homogenized at 300400 MPa.

68. The method of any one of claims 61 to 67, wherein an extraneous protein is added to the plant base.

69. The method of claim 68, wherein the extraneous protein is optionally added to the plant base prior to step (a).

70. The method of claim 68 or 69, wherein the extraneous protein is sourced from an animal or a plant.

71. The method of any one of claims 61 to 70, wherein the plurality of enzymes comprises transglutaminase, exopeptidase, and/or amylase.

72. The method of any one of claims 61 to 71, wherein probiotic bacteria are added to the plant base.

73. The method of any one of claims 61 to 72, wherein yeast and/or mold are added to the plant base.

74. The method of any one of claims 61 to 73, wherein the concentrated plant base is diluted during step (a) in water and/or another plant base.

75. The method of any one of claims 61 to 73, wherein the diluted plant base comprises no greater than 8% total carbohydrates.

76. The method of any one of claims 61 to 75, wherein the non-dairy food product comprises a reduced bitter taste compared to a non-dairy food product derived from a concentrated plant base that was not diluted and pre-concentrated.

77. The method of any one of claims 61 to 76, wherein the diluted plant base is re-concentrated during step (b) by ultra-filtration or reverse-osmosis.

78. The method of any one of claims 61 to 77, wherein the ultra-filtration is performed using a plate and frame filtration system, a spiral filtration system, or a ceramic filtration system.

79. The method of any one of claims 61 to 78, wherein the re-concentrated plant base comprises about 3-4% total protein.

80. The method of claim 79, wherein the re-concentrated plant base comprises about 3.5% total protein.

81. The method of any one of claims 61 to 80, wherein the re-concentrated plant base is fermented during step (c) at 40-46° C.

82. The method of claim 81, wherein the pre-concentrated plant base is fermented during step (c) at 43° C.

83. The method of any one of claims 61 to 82, wherein the re-concentrated plant base is fermented for at least 3 hours.

84. The method of claim 83, wherein the pre-concentrated plant base is fermented for 3-5 hours.

85. The method of any one of claims 61 to 84, wherein the fermented plant base has a pH of about 4-5.

86. The method of any one of claims 61 to 85, wherein the non-dairy food product comprises about 6-12% total protein.

87. The method of claim 86, wherein the non-dairy food product comprises about 7% total protein.

88. The method of any one of claims 61 to 87, wherein the non-dairy food product comprises no greater than 8% total carbohydrates.

89. The method of any one of claims 61 to 88, wherein the non-dairy food product comprises no greater than 5% total carbohydrates.

90. The method of any one of claims 61 to 89, wherein the non-dairy food product does not comprise an exogenous stabilizer or emulsifier.

91. The method of any one of claims 61 to 90, wherein the non-dairy food product comprises a creamy texture.

92. The method of any one of claims 61 to 91, wherein the plant base is an oat base.

93. The method of claim 92, wherein the oat base is an aqueous oat base.

94. The method of claim 92 or 93, wherein the aqueous oat base is oat milk.

95. The method of any one of claims 61 to 94, wherein the non-dairy food product does not comprise extraneous protein.

96. A non-dairy food product generated according to the method of any one of claims 1 to 95.

97. A method of producing a plant-based food product, comprising the steps of:
(a) diluting a concentrated plant base comprising greater than 3.5% total protein to form a diluted plant base;
(b) adding extraneous protein to the diluted plant base;
(c) adding lactic acid bacteria and optionally a plurality of enzymes to the diluted plant base; and
(d) fermenting the diluted plant base plant base to generate a fermented plant base; and
(e) concentrating the fermented plant base by ultra-filtration to generate a non-dairy food product comprising an increased total protein content compared to the fermented plant base.

98. The method of claim 97, wherein the extraneous protein is sourced from an animal or a plant.

99. The method of claim 98, wherein the extraneous protein is plant protein.

100. The method of any one of claims 97 to 99, wherein the plant base is diluted at least 2-fold in step (a).

101. The method of any one of claims 97 to 100, wherein the non-dairy food product comprises at least 2% total protein.

102. The method of claim 101, wherein the non-dairy food product comprises at least 6% total protein.

103. The method of claim 102, wherein the non-dairy food product comprises 6%-12% total protein.

104. The method of any one of claims 97 to 103, wherein the ultra-filtration is performed using a plate and frame filtration system, a spiral filtration system, or a ceramic filtration system.

105. The method of any one of claims 97 to 104, further comprising pasteurizing the plant base prior to step (a).

106. The method of claim 105, wherein the plant base is pasteurized at 85-95° C.

107. The method of claim 105 or 106, wherein the plant base is pasteurized for 3-7 minutes.

108. The method of any one of claims 97 to 107, further comprising homogenizing the plant base prior to step (a).

109. The method of claim 108, wherein the plant base is homogenized at 300-400 MPa.

110. The method of any one of claims 97 to 109, wherein the plurality of enzymes comprises transglutaminase, exopeptidase, and/or amylase.

111. The method of any one of claims 97 to 110, wherein probiotic bacteria are added to the plant base.

112. The method of any one of claims 97 to 111, wherein yeast and/or mold are added to the plant base.

113. The method of any one of claims 97 to 112, wherein the concentrated plant base is diluted during step (a) in water and/or another plant base.

114. The method of any one of claims 97 to 113, wherein the diluted plant base comprises no greater than 8% total carbohydrates.

115. The method of any one of claims 97 to 114, wherein the non-dairy food product comprises a reduced bitter taste compared to a non-dairy food product derived from a concentrated plant base that was not diluted.

116. The method of any one of claims 97 to 115, wherein the diluted plant base is fermented during step (c) at 43° C.

117. The method of any one of claims 97 to 116, wherein the diluted plant base is fermented for at least 3 hours.

118. The method of claim 117, wherein the diluted plant base is fermented for 3-5 hours.

119. The method of any one of claims 97 to 118, wherein the fermented plant base has a pH of about 4-5.

120. The method of any one of claims 97 to 119, wherein the non-dairy food product comprises about 6-10% total protein.

121. The method of claim 120, wherein the non-dairy food product comprises about 7% total protein.

122. The method of any one of claims 97 to 121, wherein the non-dairy food product comprises no greater than 8% total carbohydrates.

123. The method of any one of claims 97 to 122, wherein the non-dairy food product comprises no greater than 5% total carbohydrates.

124. The method of any one of claims 97 to 123, wherein the non-dairy food product does not comprise an exogenous stabilizer or emulsifier.

125. The method of any one of claims 97 to 124, wherein the non-dairy food product comprises a creamy texture.

126. The method of any one of claims 97 to 125, wherein the plant base is an oat base.

127. The method of claim 126, wherein the oat base is an aqueous oat base.

128. The method of claim 126 or 127, wherein the aqueous oat base is oat milk.

129. The method of any one of claims 97 to 128, wherein extraneous protein is not added to the non-dairy food product after step (d).

130. A non-dairy food product generated according to the method of any one of claims 97 to 129.

131. A method of producing a plant-based food product comprising the steps of;
(a) adding lactic acid bacteria and optionally enzymes to the plant base comprising no less than 3% total protein;
(b) fermenting the plant base plant base to generate a fermented plant base; and
(c) concentrating the fermented plant base by ultra-filtration to generate a non-dairy food product comprising an increased total protein content compared to the fermented plant base.

132. The method of claim 131, wherein an extraneous protein is added to the plant base.

133. The method of claim 132, wherein the extraneous protein is added to the plant base prior to step (b).

134. The method of claim 133, wherein the extraneous protein is sourced from an animal or a plant.

135. The method of any one of claims 131 to 134, wherein the non-dairy food product comprises at least 2-3% total protein.

136. The method of claim 135, wherein the non-dairy food product comprises at least 6% total protein.

137. The method of any one of claims 97 to 136, wherein the non-dairy food product comprises 6% to 12% total protein.

138. The method of any one of claims 131 to 137, wherein the ultra-filtration is performed using a plate and frame filtration system, a spiral filtration system, or a ceramic filtration system.

139. The method of any one of claims 131 to 138, further comprising pasteurizing the plant base prior to step (a).

140. The method of claim 139, wherein the plant base is pasteurized at 85-95° C.

141. The method of claim 139 or 140, wherein the plant base is pasteurized for 3-7 minutes.

142. The method of any one of claims 131 to 141, further comprising homogenizing the plant base prior to step (a).

143. The method of claim 142, wherein the plant base is homogenized at 300-400 MPa.

144. The method of any one of claims 131 to 143, wherein the plurality of enzymes comprises transglutaminase, exopeptidase, and/or amylase.

145. The method of any one of claims 131 to 144, wherein probiotic bacteria are added to the plant base.

146. The method of any one of claims 131 to 145, wherein yeast and/or mold are added to the plant base.

147. The method of any one of claims 131 to 146, wherein the plant base is fermented during step (b) at 43° C.

148. The method of any one of claims 131 to 147, wherein the plant base is fermented for at least 3 hours.

149. The method of claim 148, wherein the plant base is fermented for 3-5 hours.

150. The method of any one of claims 131 to 149, wherein the fermented plant base has a pH of about 4-5.

151. The method of any one of claims 131 to 150, wherein the non-dairy food product comprises about 6-10% total protein.

152. The method of claim 151, wherein the non-dairy food product comprises about 7% total protein.

153. The method of any one of claims 131 to 152, wherein the non-dairy food product comprises no greater than 8% total carbohydrates.

154. The method of any one of claims 131 to 153, wherein the non-dairy food product comprises no greater than 5% total carbohydrates.

155. The method of any one of claims 131 to 154, wherein the non-dairy food product does not comprise an exogenous stabilizer or emulsifier.

156. The method of any one of claims 131 to 155, wherein the non-dairy food product comprises a creamy texture.

157. The method of any one of claims 131 to 156, wherein the plant base is an oat base.

158. The method of claim 157, wherein the oat base is an aqueous oat base.

159. A non-dairy food product generated according to the method of any one of claims 131 to 158.
